(19) United States
(12) Patent Application Publication
(10) Pub. No.: US 2026/0195889 A1
(43) Pub. Date: Jul. 9, 2026

(54) PLANT DISEASE DETECTION METHOD, PRODUCT, MEDIUM, AND DEVICE

(71) Applicant: ZHEJIANG UNIVERSITY OF SCIENCE & TECHNOLOGY, Hangzhou City (CN)

(72) Inventors: Yun ZHAO, Hangzhou City (CN); Chengqiang LIN, Hangzhou City (CN); Na WU, Hangzhou City (CN); Xing XU, Hangzhou City (CN)

(21) Appl. No.: 19/011,993

(22) Filed: Jan. 7, 2025

(51) Int. Cl. G06T 7/00; G06T 3/4038

(52) U.S. Cl. CPC G06T 7/0012; G06T 3/4038; G06T 2207/20081; G06T 2207/20084; G06T 2207/30188

(57) ABSTRACT

Provided are a plant disease detection method, a product, a medium, and a device, and relates to the field of deep learning image processing technologies. The method includes: obtaining a target plant leaf image; and performing disease detection on the target plant leaf image by using a trained improved YOLO V7 network model, to obtain disease information. According to the plant disease detection method, the product, the medium, and the device provided in this application, accuracy of disease detection on plant leaves that are small in objects and have dense quantities and similar appearances can be effectively improved.

### TECHNICAL FIELD

The present disclosure relates to the field of deep learning image processing technologies, and in particular, to a plant disease detection method, a product, a medium, and a device.

### BACKGROUND

Plants play an important role in global food supply. However, various environmental factors often lead to plant diseases, which seriously affect plant growth and even yield. In the past, people used manual methods to check and prevent plant leaf diseases. This process is laborious and time-consuming and easily leads to misdiagnosis or failure to prevent the diseases in time.

In the prior art, a detector for performing disease detection is generally classified as a primary detector and a secondary detector. Currently, a relatively widely used primary detector is a YOLO series and a variant, and a secondary detector is a Faster R-CNN series and a variant. A YOLO V7 network model is a relatively advanced object detection model in recent years, which can significantly improve speed and accuracy of classification recognition and object detection. However, due to problems such as a low feature extraction capability and insufficient algorithm optimization of an existing YOLO V7 network model, a detection effect on plant diseases that are small in objects and have dense quantities are poor. Therefore, in order to overcome the shortcomings of the YOLO V7 network model in the conventional method, it is urgent to optimize the YOLO V7 network model to improve precision of detecting the plant diseases that are small in objects and have dense quantities.

### SUMMARY

An objective of the present disclosure is to provide a plant disease detection method, a product, a medium, and a device, which can effectively improve precision of disease detection on plant leaves that are small in objects and have dense quantities and similar appearances.

To achieve the above objective, the present disclosure provides the following solutions.

According to a first aspect, the present disclosure provides a plant disease detection method, including:
obtaining a target plant leaf image by a camera; and
performing disease detection on the target plant leaf image by using a trained improved YOLO V7 network model, to obtain disease information of a target plant leaf, where the disease information includes a disease category and a disease location; an improved YOLO V7 network model is constructed by optimizing a Space-to-depth Maxpool (SPD-MP) structure, Depthwise Convolution with Efficient Layer Aggregation Networks (DW-ELAN) structure and Soft-SimAM structure in an existing YOLO V7 network model; the improved YOLO V7 network model includes a backbone network, a neck network, and a head network; the backbone network and the neck network each include an optimized SPD-MP structure, an optimized DW-ELAN structure, and an optimized Soft-SimAM structure; the head network includes a RepConv structure and a Yolo Head structure; the optimized SPD-MP structure is formed by adding an SPD-Conv module to an original SPD-MP structure; the optimized DW-ELAN structure is formed by replacing a convolution module in an original DW-ELAN structure with a deep separable convolution module; and the optimized Soft-SimAM structure is formed by adding an adaptive softening threshold coefficient to an original Soft-SimAM structure.

Optionally, a training process of the trained improved YOLO V7 network model includes:
obtaining a plurality of plant leaf images and grouping them into a training data sample and test data sample, wherein the plurality of plant leaf images comprise diseased plant leaf images and disease-free plant leaf images;
preprocessing the training data sample, to obtain a preprocessed training data sample;
calibrating a location of a ground truth box on the preprocessed training data sample to obtain a calibrated training data sample, where the location of the ground truth box is an actual disease location;
training the improved YOLO V7 network model based on the calibrated training data sample by using a deep learning approach, to obtain an initial improved YOLO V7 network model; and
predicting the test data sample by using the initial improved YOLO V7 network model and updating a parameter of the initial improved YOLO V7 network model, to obtain the trained improved YOLO V7 network model.

Optionally, the preprocessing the training data sample, to obtain a preprocessed training data sample includes:
performing image size adjustment and data enhancement preprocessing on the training data sample, where an input resolution of the training data sample is adjusted to 640*640, and data enhancement preprocessing is performed by using Mix up and Mosaic data enhancement operations, to obtain the preprocessed training data sample.

Optionally, the predicting the test data sample by using the initial improved YOLO V7 network model and updating a parameter of the initial improved YOLO V7 network model, to obtain the trained improved YOLO V7 network model includes:
predicting the test data sample by using the initial improved YOLO V7 network model, and obtaining a location of a prediction box by using a first formula, where the location of the prediction box is a disease location predicted by the initial improved YOLO V7 network model;
calculating a loss value between the location of the prediction box and the location of the ground truth box by using a second formula based on the location of the prediction box; and
after performing backward propagation based on the loss value to complete updating of the parameter of the initial improved YOLO V7 network model parameter, continuing to perform training with an SGD optimizer until a predetermined condition for training completion is met, to obtain the trained improved YOLO V7 network model, where the predetermined condition for training completion may be the number of training iterations, for example, if the number of training iterations is pre-set to 300, then after 300 iterations, the training ends and the trained improved YOLO V7 are obtained.

Optionally, the first formula specifically includes:

$${x}_{1} = 2 \times σ ( {t}_{x} ) - 0.5$$

$${x}_{2} = 2.2 \times σ ( {t}_{x} ) - 0.6$$

$${y}_{1} = 2 \times σ ( {t}_{y} ) - 0.5$$

$${y}_{2} = 2.2 \times σ ( {t}_{y} ) - 0.6$$

$${b}_{x} = \{ \begin{matrix}- 0.5 + {c}_{x} , & \frac{{x}_{1} + {x}_{2}}{2} < - 0.5 \\ \frac{{x}_{1} + {x}_{2}}{2} + {c}_{x} , & - 0.5 \leq \frac{{x}_{1} + {x}_{2}}{2} \leq 1.5 \\ 1.5 + {c}_{x} , & \frac{{x}_{1} + {x}_{2}}{2} > 1.5\end{matrix}$$

$${b}_{y} = \{ \begin{matrix}- 0.5 + {c}_{y} , & \frac{{y}_{1} + {y}_{2}}{2} < - 0.5 \\ \frac{{y}_{1} + {y}_{2}}{2} + {c}_{y} , & - 0.5 \leq \frac{{y}_{1} + {y}_{2}}{2} \leq 1.5 \\ 1.5 + {c}_{y} , & \frac{{y}_{1} + {y}_{2}}{2} > 1.5\end{matrix}$$

where bₓ and b_{y} represent a location of a target center point in the prediction box; σ represents a sigmoid function; tₓ and t_{y} respectively represent offsets of target centers x and y relative to an upper left corner of a prediction box grid; cₓ and c_{y} respectively represent original x and y coordinates corresponding to the upper left corner of the prediction box grid; x₁ and x₂ respectively represent offsets of the target center x of the prediction box grid that are obtained by using offset formulas of different weights; and y₁ and y₂ respectively represent offsets of the target center y of the prediction box grid that are obtained by using offset formulas of different weights.

Optionally, the second formula specifically includes:

$$APEIOU Loss = 1 - IOU + \frac{{p}^{2} ( b , {b}^{gt} )}{{( {w}^{c} )}^{2} + {( {h}^{c} )}^{2}} + \frac{{p}^{2} ( w , {w}^{gt} )}{{( {w}^{c} )}^{2}} + \frac{{p}^{2} ( h , {h}^{gt} )}{{( {h}^{c} )}^{2}} + \frac{\sqrt{{p}^{2} ( l , {l}^{gt} ) + {p}^{2} ( r , {r}^{gt} )}}{1 + {e}^{φ} + {p}^{2} ( b , {b}^{gt} )}$$

$$φ = \frac{\sqrt{{p}^{2} ( l , {l}^{gt} ) + {p}^{2} ( r , {r}^{gt} )}}{{( {w}^{c} )}^{2} + {( {h}^{c} )}^{2}}$$

where APEIOU Loss represents the loss value between the location of the prediction box and the location of the ground truth box; p²(b,b^{gt}) represents a square of an Euclidean distance between a center point b^{gt} of the ground truth box and a center point b of the prediction box; p²(w,w^{gt}) represents a square of an Euclidean distance between a width w of the prediction box and a width w^{gt} of the ground truth box; p²(h,h^{gt}) represents a square of an Euclidean distance between a height h of the prediction box and a height h^{gt} of the ground truth box; p²(l,l^{gt}) represents a square of an Euclidean distance between an upper left corner l^{gt} of the ground truth box and an upper left corner l of the prediction box; p²(r,r^{gt}) represents a square of an Euclidean distance between a lower right corner r^{gt} of the ground truth box and a lower right corner r of the prediction box; w^{c} and h^{c} respectively represent a width and a height of a minimum bounding rectangle of a prediction bounding box and a ground truth bounding box; and IOU represents an intersection over union of areas of the prediction box and the ground truth box.

Optionally, the trained improved YOLO V7 network model further includes a third formula, and the third formula is specifically:

$${X}^{*} = X \times σ ( α \times E - mean ( E ) )$$

where X is an input feature, and X* is a weighted feature; E is a neuron weight; mean(E) represents a mean value of the neuron weight; and α is a threshold coefficient of a threshold softening operation.

According to a second aspect, the present disclosure provides a computer program product, including a computer program, where the computer program, when executed by a processor, implements the plant disease detection method.

According to a third aspect, the present disclosure provides a computer-readable storage medium, having a computer program stored therein, where the computer program, when executed by a processor, implements the plant disease detection method.

According to a fourth aspect, the present disclosure provides a computer device, including: a memory, a processor, and a computer program stored in the memory and executable on the processor, where the processor executes the computer program, to implement the plant disease detection method.

According to specific embodiments provided in the present disclosure, the present disclosure discloses the following technical effects:

The present disclosure provides a plant disease detection method, a product, a medium, and a device, an overall network architecture of an existing YOLO V7 network model is optimized, attention on a small object is enhanced by using a Yolo Head structure with a size 160*160, a model parameter and a calculation amount are reduced by using a depth-wise convolution with efficient layer aggregation network (DW-ELAN) structure formed by deep convolution, and a down sampling process is optimized by using an improved space-to-depth maxpool down sampling layer (SPD-MP) structure. Then, in the present disclosure, a softening threshold-simple and parameter-free attention module (Softening threshold, A Simple, Parameter-Free Attention Module, Soft-SimAM) structure is improved, so that the improved YOLO V7 network model pays more attention to an important feature and suppresses unimportant information. According to the plant disease detection method in the present disclosure, global information extraction and small object detection capabilities of the existing YOLO V7 network model are enhanced through multi-scale feature fusion, and an entire process from extraction of disease information of a plant leaf to recognition and detection is intelligently completed by using the improved YOLO V7 network model. Therefore, according to the plant disease detection method, the product, the medium, and the device provided in the present disclosure, robustness is strong, a detection effect is excellent, precision of disease detection on plant leaves that are small in objects and have dense quantities and similar appearances can be effectively improved.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a diagram of an application environment of a plant disease detection method according to the present disclosure;

FIG. 2 is a schematic flowchart of a plant disease detection method according to the present disclosure;

FIG. 3 is a schematic diagram of a detection process of the improved YOLO V7 network model according to the present disclosure;

FIGS. 4A-4B are schematic diagrams of Mix up and Mosaic data enhancement according to the present disclosure;

FIG. 5 is a schematic diagram of an optimized SPD-MP structure according to the present disclosure;

FIG. 6 is a schematic diagram of an optimized DW-ELAN structure according to the present disclosure;

FIG. 7 is a schematic diagram of a prediction box grid used when a target center point falls in a first quadrant of a grid of a feature map according to the present disclosure;

FIG. 8 is a principle diagram of a plant disease detection method according to the present disclosure;

FIGS. 9A-9J are schematic diagrams of comparison between detection effects obtained by using models; and

FIGS. 10A-10E are schematic diagrams of comparison between significance of results obtained by using models.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

For a technical problem in the prior art that disease detection on plant leaves that are small in objects and have dense quantities and similar appearances has relatively large difficulty, a relatively large error, and low precision, the present disclosure is intended to provide a plant disease detection method, a product, a medium, and a device, which can effectively improve precision of disease detection on plant leaves that are small in objects and have dense quantities and similar appearances.

To make the above objectives, features, and advantages of the present disclosure more obvious and easy to understand, the present disclosure will be further described in detail with reference to the accompanying drawings and specific implementations.

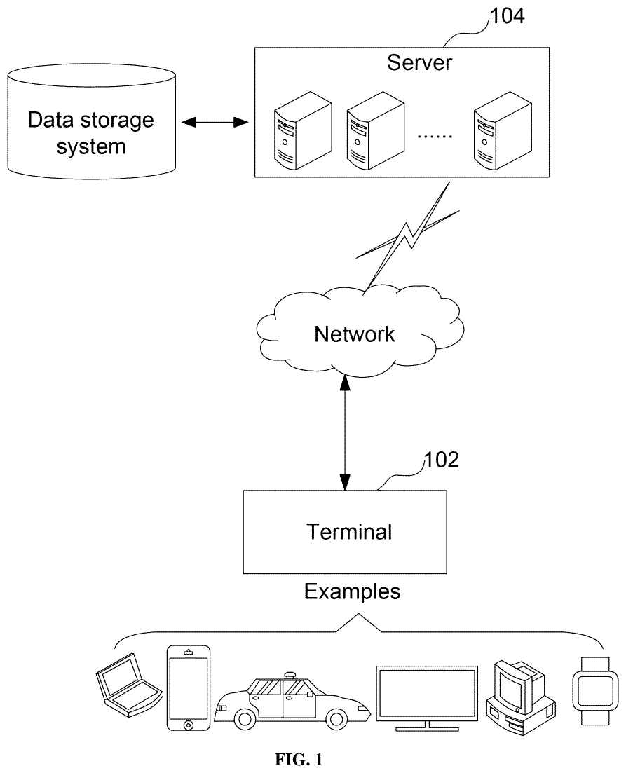

The plant disease detection method provided in the present disclosure may be applied to an application environment shown in FIG. 1. A terminal 102 communicates with a server 104 through a network. A data storage system may store data that needs to be processed by the server 104. The data storage system may be disposed independently, may be integrated on the server 104, or may be placed on a cloud or another server. The terminal 102 may send a target plant leaf image to the server 104. After the server 104 receives the target plant leaf image, the server 104 inputs the target plant leaf image into a trained improved YOLO V7 network model for disease detection, to obtain disease information. The server 104 may feed back the obtained disease information to the terminal 102. In addition, in some embodiments, the plant disease detection method may alternatively be implemented by the server 104 or the terminal 102 independently. For example, the terminal 102 may directly perform disease detection on the target plant leaf image, or the server 104 may obtain the target plant leaf image from the data storage system, and perform disease detection on the target plant leaf image.

The terminal 102 may be but is not limited to various desktop computers, notebook computers, smartphones, tablet computers, internet of things devices, and portable wearable devices. The internet of things device may be a smart speaker, a smart television, a smart air conditioner, a smart vehicle-mounted device, or the like. The portable wearable device may be a smart watch, a smart band, a head device, or the like. The server 104 may be implemented by a standalone server or a server cluster including a plurality of servers, or may be a cloud server.

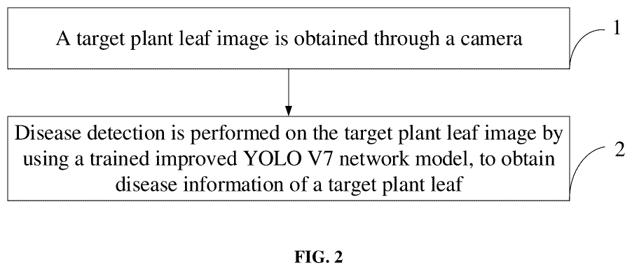

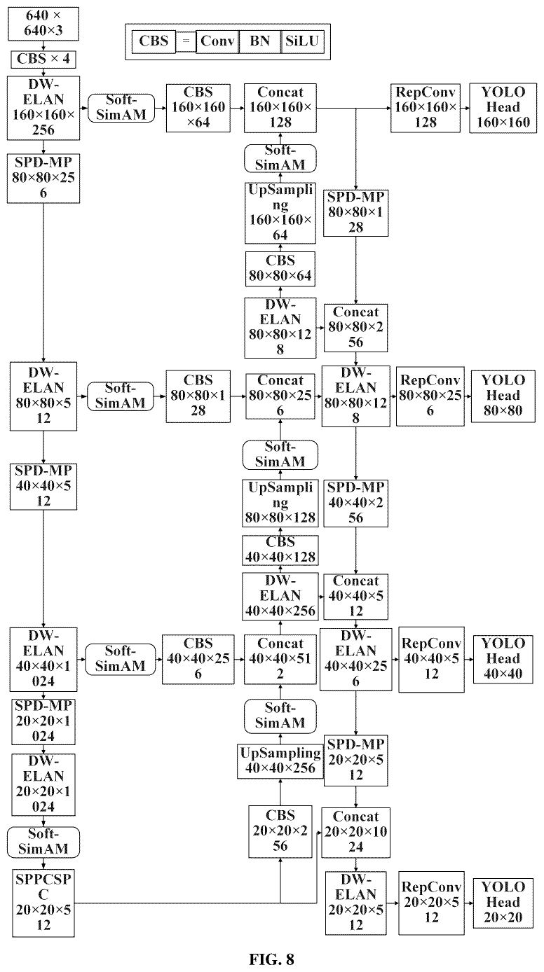

As shown in FIG. 2 and FIG. 8, a plant disease detection method disclosed in the present disclosure includes the following steps.

Step 1: a target plant leaf image is obtained through a camera.

In the present disclosure, the target plant leaf image is obtained directly, such as photographing a plant leaf by using the camera, or obtained indirectly, such as downloading data in a public data set to obtain a plant leaf image sample in a picture format, so as to obtain the target plant leaf image.

Step 2: a disease detection is performed on the target plant leaf image by using a trained improved YOLO V7 network model, to obtain disease information of a target plant leaf; where an improved YOLO V7 network model is constructed by optimizing a Space-to-depth Maxpool (SPD-MP) structure, Depthwise Convolution with Efficient Layer Aggregation Networks (DW-ELAN) structure and Soft-SimAM structure in an existing YOLO V7 network model.

After the target plant leaf image is obtained, the target plant leaf image is inputted into the trained improved YOLO V7 network model, and classification and object detection are performed on the target plant leaf image, to obtain a disease category and positioning information as the disease information.

As shown in FIG. 8, in the present disclosure, the trained improved YOLO V7 network model includes a backbone network, a neck network, and a head network. In the backbone network part, the inputted target plant leaf image is processed by using a plurality of CBS structures (one convolution Conv+one batch normalization BN+one SiLU activation function SiLU), a plurality of optimized SPD-MP structures, a plurality of optimized DW-ELAN structures, a plurality of optimized Soft-SimAM structures (lightweight attention structures), and a plurality of spatial pyramid pooling and cross stage partial network concatenation (SPPCSPC) structures, to gradually reduce a size of a feature map and increase a quantity of channels, so as to retain and extract an important feature in the image. The neck network includes a plurality of optimized SPD-MP structures, a plurality of optimized DW-ELAN structures, a plurality of optimized Soft-SimAM structures, a plurality of CBS structures, a plurality of concatenation operations, and a plurality of up sampling operations. Based on the important feature extracted by the backbone network, feature fusion of different sizes and an up sampling operation are further performed, to improve more advanced semantic information and adapt to image information of different sizes, enrich a feature expression capability, and accurately represent leaf disease information. The head network includes four re-parameter convolution (RepConv) structures and four YOLO Head structures. Features of different sizes are fused and converted, higher-layer semantic information and a context relationship are captured, and final output information is generated. When the four RepConv structures are trained, a special residual structure is introduced to assist in training, so that network complexity can be reduced without reducing prediction performance. The four YOLO Head structures may obtain four different size prediction results, which are 20*20, 40*40, 80*80, and 160*160 respectively and correspond to prediction results of a large object, a middle object, a small object, and a micro object.

Specifically, the backbone network includes an efficient layer aggregation network (ELAN-Net) and one SPPCSPC structure after the ELAN-Net network, that is, the ELAN-Net network is a general name of all structures except the SPPCSPC structure in the DW-ELAN structure. The SPPCSPC structure is formed by a dual-branch feature. The left branch first passes through three CBS structures, and then four-branch feature fusion is performed by using a feature Identity of the left branch, a maximum pooling layer whose convolution kernel size is 5, a maximum pooling layer whose convolution kernel size is 9, and a maximum pooling layer whose convolution kernel size is 13. The right branch passes through only one CBS structure, and finally a concatenation operation is performed on the left and right branch features and further processing is performed by using one CBS structure. One optimized Soft-SimAM structure is formed by combining an original Soft-SimAM structure and an adaptive softening threshold coefficient.

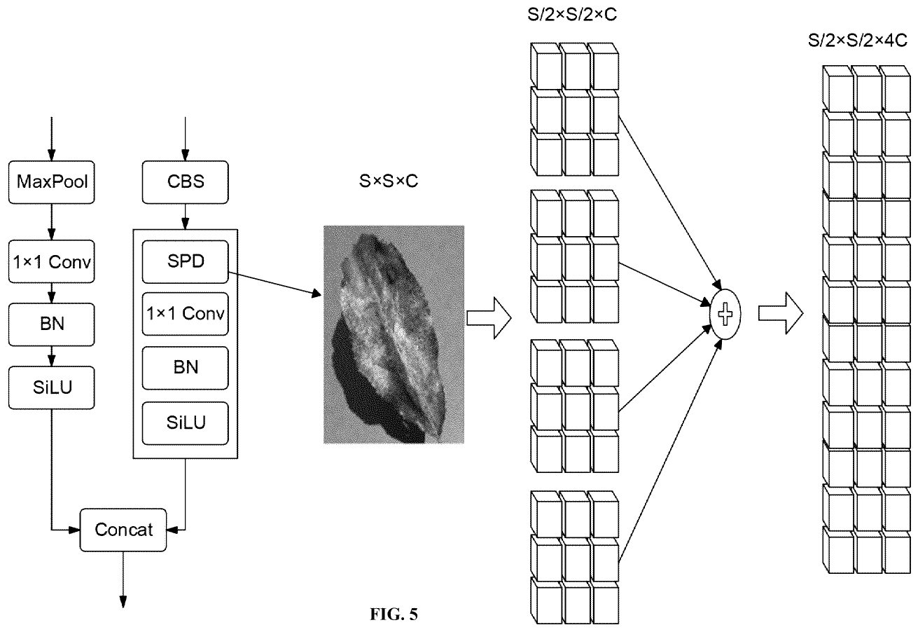

The neck network includes six CBS structures, five lightweight optimized DW-ELAN structures, three optimized SPD-MP structures, and six optimized Soft-SimAM structures. Referring to FIG. 5, in the optimized SPD-MP structure, a multi-branch down sampling structure is formed by one maximum pooling layer, three CBS structures, one space-to-depth Conv (SPD-Conv) module, and one concatenation operation. Specifically, C in the figure represents a quantity of dimensions of a channel of an inputted image, and S represents a width and a height of the inputted image. In the optimized SPD-MP structure, an upper-layer input is divided into two parts. The left branch includes one maximum pooling layer and one CBS structure. The right branch includes two CBS structures and one SPD-Conv module. The two parts can extract different feature information of an input layer, to avoid data redundancy caused by repeatedly extracting a same feature. Finally, features of the two branches are concatenated and fused. In this structure, a size of a space dimension can be reduced without missing information. In addition, information in a channel is reserved, and a disease detection effect of the YOLO V7 network model on a small object is optimized.

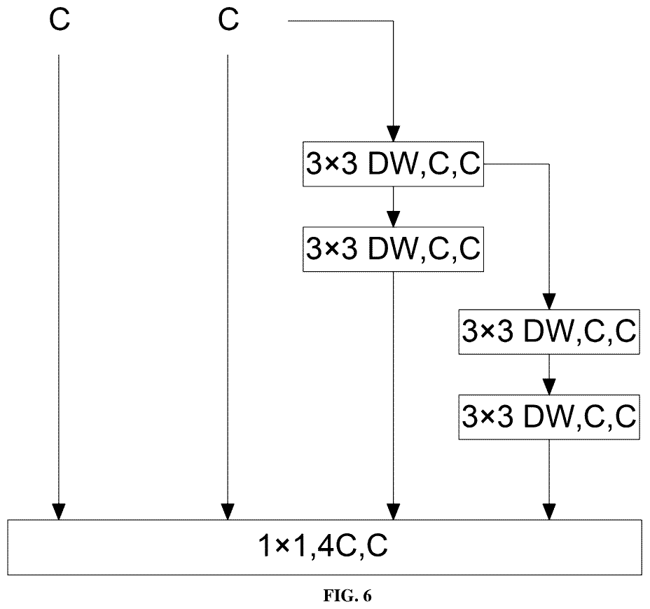

Referring to FIG. 6, in the optimized DW-ELAN structure, a multi-branch network structure is formed by replacing a CBS structure in a standard convolution module and one concatenation operation with three standard CBS structures and four deep separable convolution modules. A quantity of parameters used by deep separable convolution DW is far less than a quantity of parameters used by ordinary convolution, so that the quantity of parameters and a calculation amount can be greatly reduced in a case of slight loss of precision.

Based on the foregoing, in the present disclosure, the optimized SPD-MP structure is formed by adding the SPD-Conv module in an original structure, the optimized DW-ELAN structure is formed by replacing the original convolution module with the deep separable convolution module, and the optimized Soft-SimAM structure is formed by adding the adaptive softening threshold coefficient to an original structure and is implemented by using a third formula.

Compared with a complex feature extraction process in a conventional algorithm, the improved YOLO V7 network model can quickly and conveniently extract features of an image, including a color, a texture, a shape, and the like of the image. In an image detection problem, through a multi-layer image feature extraction module (YOLO Head structure), both detail information having rich low-level features and semantic information having rich high-level features can be extracted, to obtain better feature robustness.

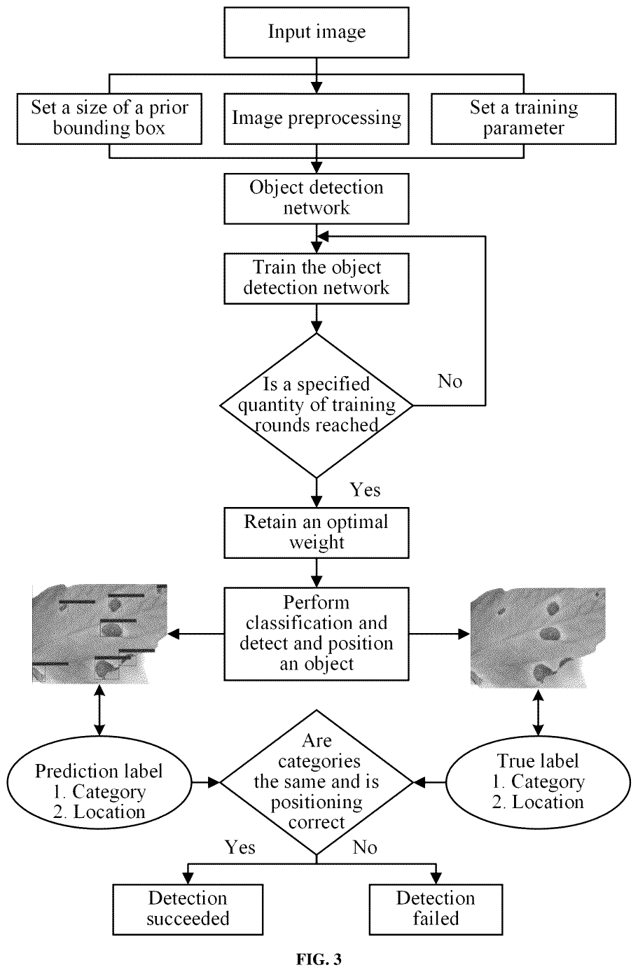

As shown in FIG. 3, the improved YOLO V7 network model is trained by using a sample in advance. The training process specifically includes the following content.

First, a training data sample is obtained, a size of a prior bounding box is set, a preprocessing parameter and a training parameter are set, and the training data sample is preprocessed, to obtain a preprocessed training data sample. Setting the size of the prior bounding box refers to obtaining a group of recommended prediction size boxes in the training data sample by using a K-means clustering algorithm, and the prior bounding box is used for helping the improved YOLO V7 network model fit a ground truth box better in a learning process. Therefore, it may be simply understood that the prior bounding box is used for predicting a size and a location of an object, so as to help the improved YOLO V7 network model improve detection accuracy. The training parameter mainly includes a parameter of an SGD optimizer used in the training process. A momentum parameter is 0.937, a learning rate is set to be automatically adjusted, an initial learning rate is 0.01, a minimum learning rate is not less than 0.0001, resolution of a preprocessed training image is 640*640, a quantity of training rounds is 300, a batch size is set to 8, and the like.

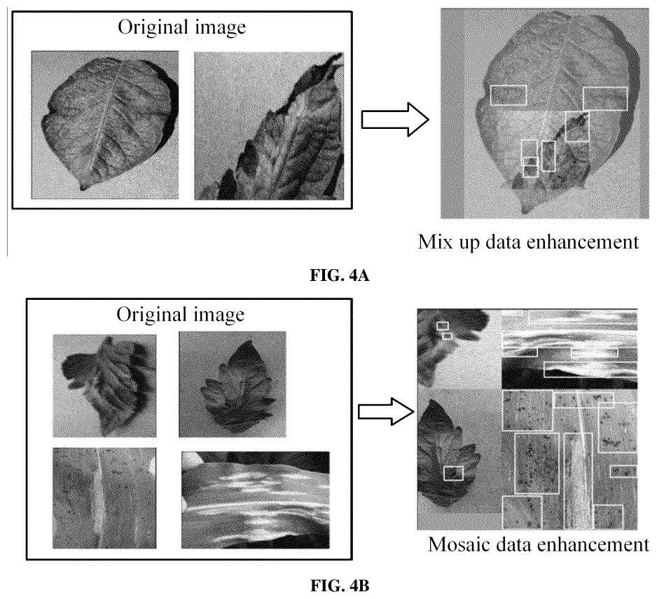

Specifically, as shown in FIGS. 4A-4B, after the training data sample is obtained, image size adjustment and data enhancement preprocessing are performed. An input resolution of the training data sample is adjusted to 640*640, and data enhancement preprocessing is performed by using Mix up and Mosaic data enhancement operations, to obtain the preprocessed training data sample, so that diversity of the training data sample is enhanced, and the improved YOLO V7 network model can adapt to different environments and has higher robustness.

Then, a location of a ground truth box is calibrated on the preprocessed training data sample, where the location of the ground truth box is an actual disease location. The improved YOLO V7 network model is trained based on the calibrated training data sample by using a deep learning approach, a weight parameter with an optimal test effect is determined, and an initial improved YOLO V7 network model is obtained according to the optimal weight parameter.

Finally, a test data sample is predicted by using the initial improved YOLO V7 network model, and a parameter of the initial improved YOLO V7 network model is updated, to obtain the trained improved YOLO V7 network model. The training data sample and the test data sample are obtained by grouping multiple plant leaf images, where the multiple plant leaf images include an image of diseased plant leaf and image of disease-free plant leaf. Specifically, after the test data sample is predicted by using the initial improved YOLO V7 network model, a prediction box is obtained. A sample image feature is extracted through calculation by using a first formula, to determine a location of the prediction box relative to the ground truth box, so as to obtain a location of the prediction box. The location of the prediction box is a disease location predicted by the initial improved YOLO V7 network model. Then, the location of the prediction box relative to the ground truth box is calculated by using a second formula based on the location of the prediction box, to obtain a loss value between the location of the prediction box and the location of the ground truth box. After backward propagation is performed based on the loss value to complete updating of the parameter of the initial improved YOLO V7 network model, training continues to be performed with an SGD optimizer until a predetermined condition for training completion is met, to obtain the trained improved YOLO V7 network model.

In the improved YOLO V7 network model, 12 groups of anchor values are preset. A center point of each preset anchor value falls in an upper left corner of a prediction grid (a prediction box grid), and then an offset in which the prediction box gradually shifts to a target center point is calculated by using a first formula, and a better effect is obtained when the prediction box is closer to the target center point.

The first formula specifically includes:

$${x}_{1} = 2 \times σ ( {t}_{x} ) - 0.5 \qquad ( 1 )$$

$${x}_{2} = 2.2 \times σ ( {t}_{x} ) - 0.6 \qquad ( 2 )$$

$${y}_{1} = 2 \times σ ( {t}_{y} ) - 0.5 \qquad ( 3 )$$

$${y}_{2} = 2.2 \times σ ( {t}_{y} ) - 0.6 \qquad ( 4 )$$

$${b}_{x} = \{ \begin{matrix}- 0.5 + {c}_{x} , & \frac{{x}_{1} + {x}_{2}}{2} < - 0.5 \\ \frac{{x}_{1} + {x}_{2}}{2} + {c}_{x} , & - 0.5 \leq \frac{{x}_{1} + {x}_{2}}{2} \leq 1.5 \\ 1.5 + {c}_{x} , & \frac{{x}_{1} + {x}_{2}}{2} > 1.5\end{matrix} \qquad ( 5 )$$

$${b}_{y} = \{ \begin{matrix}- 0.5 + {c}_{y} , & \frac{{y}_{1} + {y}_{2}}{2} < - 0.5 \\ \frac{{y}_{1} + {y}_{2}}{2} + {c}_{y} , & - 0.5 \leq \frac{{y}_{1} + {y}_{2}}{2} \leq 1.5 \\ 1.5 + {c}_{y} , & \frac{{y}_{1} + {y}_{2}}{2} > 1.5\end{matrix} \qquad ( 6 )$$

where bₓ and b_{y} represent a location of a target center point in the prediction box; σ represents a sigmoid function; tₓ and t_{y} respectively represent offsets of target centers x and y relative to an upper left corner of a prediction box grid; cₓ and c_{y} respectively represent original x and y coordinates corresponding to the upper left corner of the prediction box grid; x₁ and x₂ respectively represent offsets of the target center x of the prediction box grid that are obtained by using offset formulas of different weights; and y₁ and y₂ respectively represent offsets of the target center y of the prediction box grid that are obtained by using offset formulas of different weights.

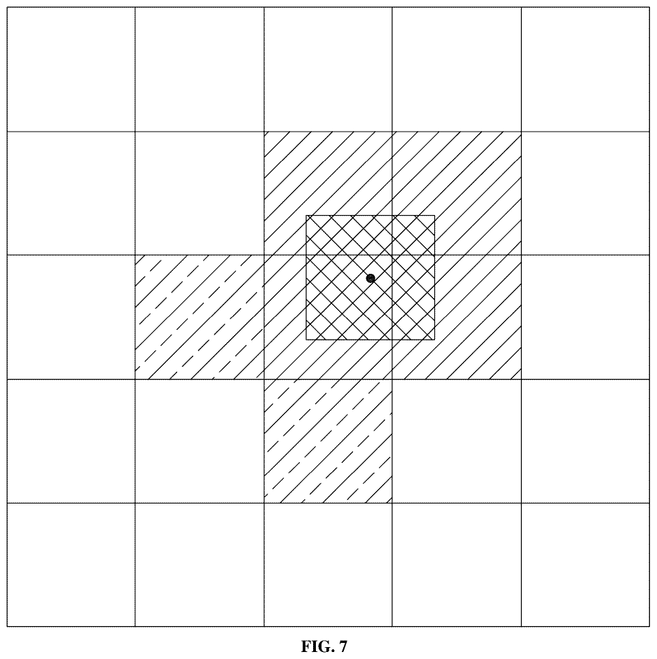

As shown in FIG. 7, when the target center point falls in a first quadrant of a grid of a feature map, main used prediction grids are four black solid line grids, and auxiliary prediction grids are four black solid line grids and two black dashed line grids. A black point is a center point of the ground truth box, and a black solid line grid in an upper right corner of the black point is an additional matching grid used for increasing a quantity of positive samples in the training process. In the formula, two offset values are obtained by using two different offset calculation methods, and then a final offset value is obtained by obtaining a mean value of the two offset values. In this way, all required values are included, and a maximum value and a minimum value are set in a piecewise function manner, to avoid a case that a value of an original formula is exceeded. A value range of the original formula bₓ is (−0.5+cₓ, 1.5+cₓ), and a value range of b_{y} is (−0.5+c_{y}, 1.5+c_{y}). In an actual case, when an offset of a center of the prediction box needs to be 1.5 or −0.5, t_{y} needs to tend to be +∞ or tₓ needs to tend to be −∞, and a bounding value can be obtained more easily by using the modified formula.

The location of the prediction box relative to the ground truth box is calculated by using a second formula, and a loss value between a prediction result and a true result is obtained through calculation. A loss value between the prediction box and the ground truth box is calculated by using a loss function calculation formula, and then backward propagation is performed according to the loss value to update the parameter of the model, so that model positioning is more accurate and recognition accuracy is higher. A formula that is improved based on an original loss function, that is, the second formula, specifically includes:

$$APEIOU Loss = 1 - IOU + \frac{{p}^{2} ( b , {b}^{gt} )}{{( {w}^{c} )}^{2} + {( {h}^{c} )}^{2}} + \frac{{p}^{2} ( w , {w}^{gt} )}{{( {w}^{c} )}^{2}} + \frac{{p}^{2} ( h , {h}^{gt} )}{{( {h}^{c} )}^{2}} + \frac{\sqrt{{p}^{2} ( l , {l}^{gt} ) + {p}^{2} ( r , {r}^{gt} )}}{1 + {e}^{φ} + {p}^{2} ( b , {b}^{gt} )} \qquad ( 7 )$$

$$φ = \frac{\sqrt{{p}^{2} ( l , {l}^{gt} ) + {p}^{2} ( r , {r}^{gt} )}}{{( {w}^{c} )}^{2} + {( {h}^{c} )}^{2}} \qquad ( 8 )$$

where APEIOU Loss represents the loss value between the location of the prediction box and the location of the ground truth box; p²(b,b^{gt}) represents a square of an Euclidean distance between a center point b^{gt} of the ground truth box and a center point b of the prediction box; p²(w,w^{gt}) represents a square of an Euclidean distance between a width w of the prediction box and a width w^{gt} of the ground truth box; p²(h,h^{gt}) represents a square of an Euclidean distance between a height h of the prediction box and a height h^{gt} of the ground truth box; p²(l, l^{gt}) represents a square of an Euclidean distance between an upper left corner l^{gt} of the ground truth box and an upper left corner l of the prediction box; p²(r,r^{gt}) represents a square of an Euclidean distance between a lower right corner r^{gt} of the ground truth box and a lower right corner r of the prediction box; w^{c} and h^{c} respectively represent a width and a height of a minimum bounding rectangle of a prediction bounding box and a ground truth bounding box; and IOU represents an intersection over union of areas of the prediction box and the ground truth box.

When a distance between the prediction box and the ground truth box is longer, a denominator increases faster than a molecule, so that a penalty term φ tends to be 0. This ensures that the penalty item does not affect a loss value 0 when there is no intersection between the two boxes. However, when a center point of the prediction box is closer to a center point of the ground truth box, p²(b,b^{gt}) tends to be 0. Generally, \sqrt{p²(l,l^{gt})+p²(r,r^{gt})} also becomes smaller. Certainly, there may also be a case that a distance between an upper left corner and a lower right corner of the ground truth box and the prediction box is relatively large although the center points overlap, and in this case, a relatively large loss value is given to an auxiliary penalty item.

In the present disclosure, the APEIOU Loss can successfully distinguish a case that the center point of the prediction box overlaps the center point of the ground truth box, and losses of the prediction box and the ground truth box are the same when aspect ratios are the same but aspect values are different, and calculated loss values of different prediction boxes are also different, so that a fitting situation between the ground truth box and the prediction box can be better described, and the added auxiliary penalty term function ensures that the APEIOU Loss is always non-negative.

Based on the foregoing, in the present disclosure, to resolve a problem that the center point of the prediction box overlaps the center point of the ground truth box, and the losses are the same when the aspect ratios are the same but the aspect values are different, an auxiliary penalty-enhanced efficient IOU loss (APEIOU Loss) is proposed, an offset formula and a grid matching policy are improved, a quantity of positive samples is increased, and more choices are provided for a similarity overlap threshold assigner (SimOTA) positive sample filtering policy.

In addition, in the training process, in the present disclosure, a third formula, that is, a formula of the Soft-SimAM structure, is further used for allocating weights between different neurons, so as to help the improved YOLO V7 network model distinguish and learn importance of different features. The third formula specifically includes:

$${X}^{*} = X \times σ ( α \times E - mean ( E ) ) \qquad ( 9 )$$

where X is an input feature, and X* is a weighted feature; E is a neuron weight; mean(E) represents a mean value of the neuron weight; and α is a threshold coefficient of a threshold softening operation.

In the present disclosure, mean average precision (mAP) of plant leaf disease detection may be calculated according to a result obtained by using the improved YOLO V7 network model, and a detection effect of the improved YOLO V7 network model is compared with that in the prior art according to the mean average precision. Higher mAP indicates a better detection effect of the model.

In a specific embodiment, to verify accuracy of the plant disease detection method in the present disclosure, mixed training and test are performed on five diseases of five plants such as apple, corn, grape, potato, tomato, and potato, and the accuracy is compared with that of another detection network model.

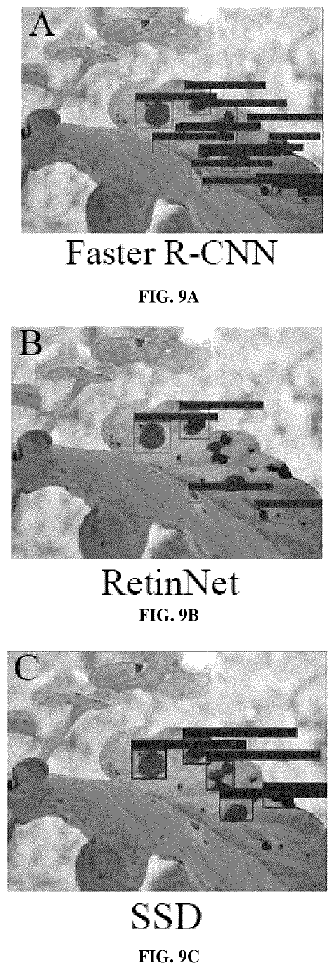

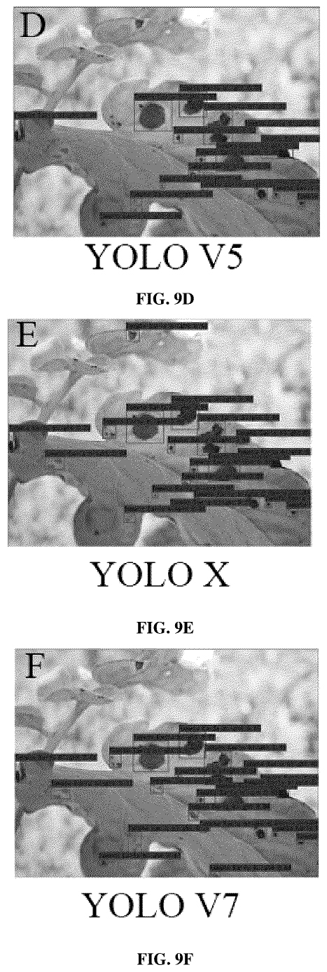

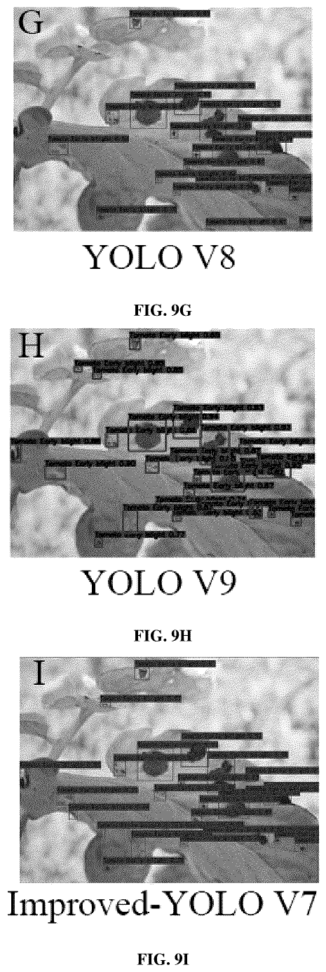

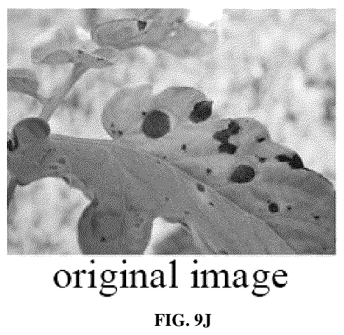

As shown in FIGS. 9A-9J, for test of a mixed data set of a plurality of plant diseases, as shown in Table 1, Table 1 shows experimental results of mixed tests of the improved YOLO V7 network model (Improved-YOLO V7) in the present disclosure and eight other detection models (Faster R-CNN, RetinaNet, SSD, YOLO V5, YOLO X, existing YOLO V7, YOLO V8, and YOLO V9) on a plant leaf disease data set. The experimental results include mAP values of the models, which are specifically a mAP value of a small object whose resolution is less than 32*32, a quantity of model parameters Params, a model calculation amount FLOPs, a model F1 value, a model recall rate Recall, and model precision Precision. A preset quantity of model parameters is 26.35M, a calculation amount is 74.24 G, and a mAP value of a model, an F1 value, a recall rate, and precision are 96.75%, 0.94, 89.69%, and 97.64% respectively. It can be learned from Table 1 that the improved YOLO V7 network model has a higher mAP value than a model with a larger quantity of parameters and a larger calculation amount, and performance of the improved YOLO V7 network model is only slightly lower than a newest baseline model YOLO V9, but a calculation mount of the improved YOLO V7 network model in the present disclosure is 28.56 G less than that of the newest baseline model YOLO V9, and it indicates that the improved YOLO V7 network model in the present disclosure has better performance

TABLE 1
Experimental results of detection models

| | mAP | mAP(%) | Params | FLOPs | | Recall | Precision |
|---|---|---|---|---|---|---|---|
| Model | (%) | small obj. | (M) | (G) | F1 | (%) | (%) |
| Faster R-CNN | 79.61 | 27.9 | 136.77 | 370.01 | 0.65 | 84.73 | 52.94 |
| RetinaNet | 85.21 | 43.9 | 55.40 | 201.16 | 0.83 | 74.40 | 94.17 |
| SSD | 80.96 | 32.4 | 26.28 | 62.80 | 0.71 | 59.69 | 92.44 |
| YOLO V5 | 92.34 | 47.6 | 46.65 | 114.30 | 0.86 | 79.50 | 95.23 |
| YOLO X | 95.80 | 55.7 | 54.15 | 155.38 | 0.92 | 89.58 | 95.21 |
| Existing YOLO V7 | 90.96 | 48.0 | 37.21 | 104.83 | 0.87 | 80.26 | 94.34 |
| YOLO V8 | 95.82 | 58.0 | 25.85 | 79.07 | 0.93 | 89.61 | 96.63 |
| YOLO V9 | 97.06 | 58.6 | 25.44 | 102.8 | 0.94 | 90.20 | 96.91 |
| Improved-YOLO V7 | 96.75 | 58.1 | 26.35 | 74.24 | 0.94 | 89.69 | 97.64 |

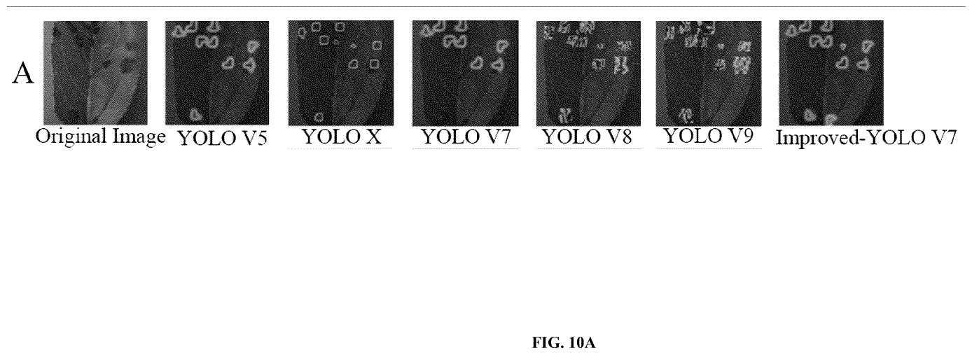

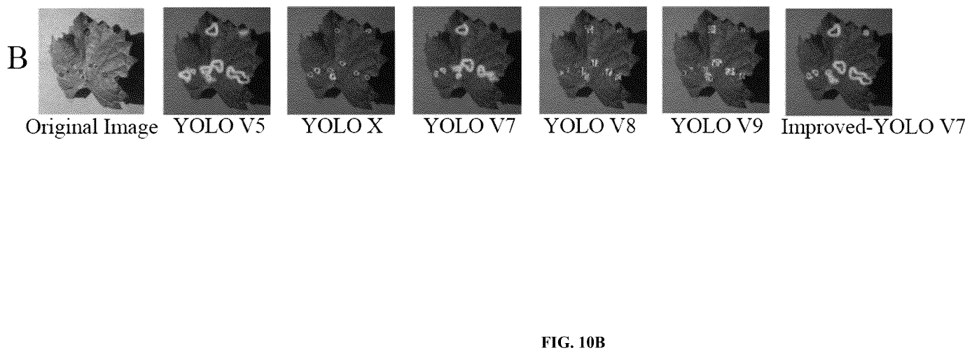

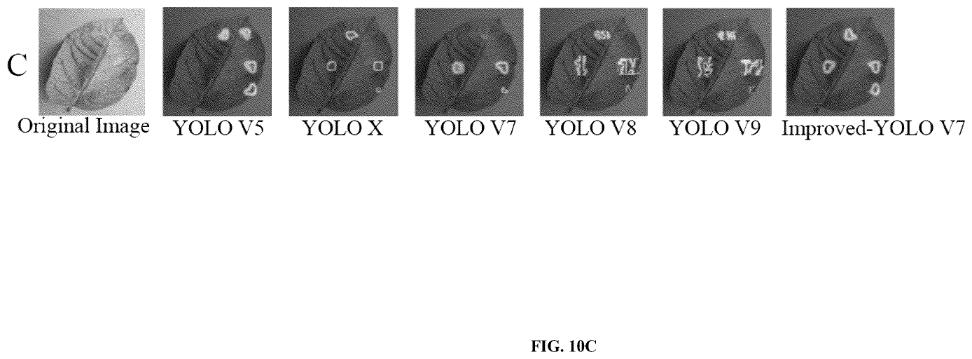

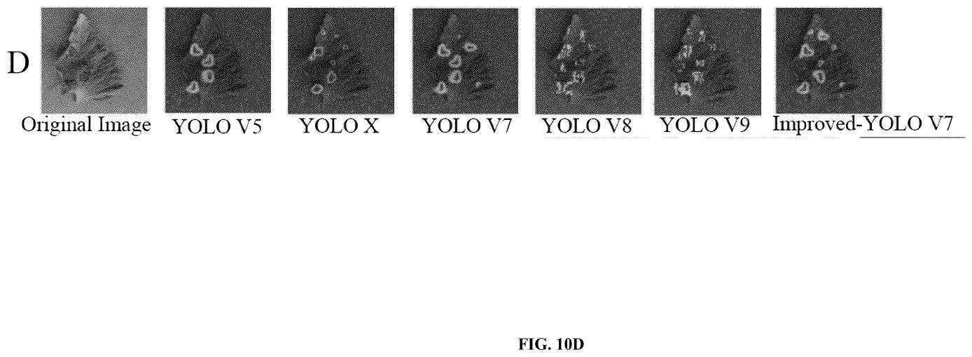

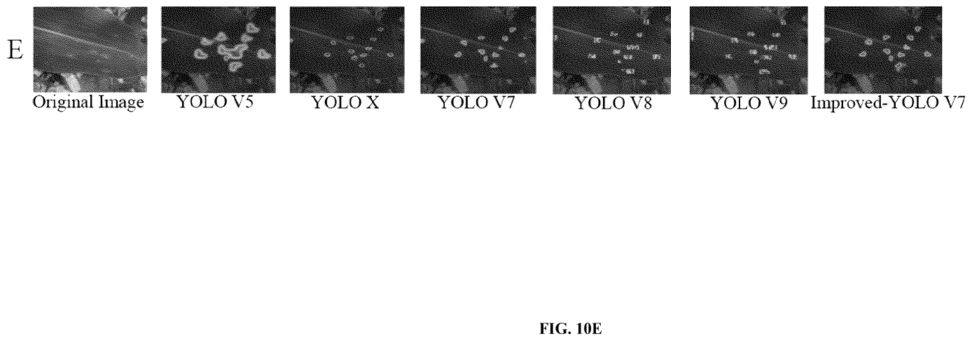

Referring to FIGS. 10A-10E, to more clearly display detection effects of different YOLO series, in the present disclosure, heat maps of different types of diseases are visualized on the YOLO series models, where A represents apple scab B represents grape black rot, C represents potato late blight, D represents tomato early blight, and E represents corn leaf blight. Compared with another model, the improved YOLO V7 network model in the present disclosure pays more attention to disease coverage, and detects small diseases more effectively. It indicates that the improved YOLO V7 network model in the present disclosure can focus on more disease fields, and also has a better detection effect on diseases of small objects. In conclusion, in the present disclosure, the detection effect of the improved YOLO V7 network model is relatively excellent. According to the plant disease detection method provided in the present disclosure, a global network information extraction capability is enhanced, the problem that the center point of the prediction box overlaps the center point of the ground truth box, and the losses of the prediction box and the ground truth box are the same when the aspect ratios are the same but the aspect values are different is resolved, and finally, plant leaf disease recognition and detection are performed, thereby successfully resolving a problem that a disease detection effect on plant leaves that are small in objects and have dense quantities is not good. In addition, the improved YOLO V7 network model in the present disclosure shows relatively high mean average precision when an IOU threshold is 0.5, especially in terms of small object detection, and has strong robustness and good detection effect.

In some embodiments, the present disclosure further provides a computer program product, including a computer program. The computer program, when executed by a processor, implements the plant disease detection method.

In some embodiments, the present disclosure further provides a computer-readable storage medium, having a computer program stored therein. The computer program, when executed by a processor, implements the plant disease detection method.

In some embodiments, the present disclosure further provides a computer device, including a processor, a memory, an input/output (I/O) interface, a communication interface, and a computer program stored on the memory and executable on the processor. The processor executes the computer program to implement the plant disease detection method.

The processor, the memory, and the input/output interface are connected through a system bus, and the communication interface is connected to the system bus through the input/output interface. The processor of the computer device is configured to provide computing and control capabilities. The memory of the computer device includes a nonvolatile storage medium and an internal memory. The non-volatile storage medium stores an operating system, a computer program, and a database. The internal memory provides an environment for operation of the operating system and the computer program in the nonvolatile storage medium. The database of the computer device is configured to store pending transactions. The input/output interface of the computer device is configured to exchange information between the processor and an external device. The communication interface of the computer device is configured to communicate with an external terminal through a network. The computer program, when executed by the processor, by the implements the plant disease detection method.

It should be noted that information of an object (including but not limited to device information of the object, personal information of the object and the like) and data (including but not limited to data for analysis, data for storage, data for exhibition and the like) in the present disclosure are information and data authorized by the object or fully authorized by each party, and relevant data shall be acquired, used and processed according to laws, regulations and standards of related countries and regions.

A person of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory. As an illustration rather than a limitation, the RAM may be in various forms, such as a static random access memory (SRAM) or a dynamic random access memory (DRAM). The database in the embodiments of the present disclosure may include at least one of a relational database and a non-relational database. The non-relational database may include a distributed database based on a blockchain, but is not limited thereto. The processor in the embodiments of the present disclosure may be a general processor, a central processing unit, a graphics processing unit, a digital signal processor, a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the foregoing examples is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

What is claimed is:

1. A plant disease detection method, comprising:
obtaining a target plant leaf image through a camera; and
performing disease detection on the target plant leaf image by using a trained improved YOLO V7 network model, to obtain disease information of a target plant leaf, wherein the disease information comprises a disease category and a disease location; an improved YOLO V7 network model is constructed by optimizing a Space-to-depth Maxpool (SPD-MP) structure, Depthwise Convolution with Efficient Layer Aggregation Networks (DW-ELAN) structure and Soft-SimAM structure in an existing YOLO V7 network model; the improved YOLO V7 network model comprises a backbone network, a neck network, and a head network; the backbone network and the neck network each comprise an optimized SPD-MP structure, an optimized DW-ELAN structure, and an optimized Soft-SimAM structure; the head network comprises a RepConv structure and a Yolo Head structure; the optimized SPD-MP structure is formed by adding a Space-to-depth Conv (SPD-Conv) module to an original SPD-MP structure; the optimized DW-ELAN structure is formed by replacing a convolution module in an original DW-ELAN structure with a deep separable convolution module; and the optimized Soft-SimAM structure is formed by adding an adaptive softening threshold coefficient to an original Soft-SimAM structure.

2. The plant disease detection method according to claim 1, wherein a training process of the trained improved YOLO V7 network model comprises:
obtaining a plurality of plant leaf images and grouping them into a training data sample and test data sample, wherein the plurality of plant leaf images comprise diseased plant leaf images and disease-free plant leaf images;
preprocessing the training data sample, to obtain a preprocessed training data sample;
calibrating a location of a ground truth box on the preprocessed training data sample to obtain a calibrated training data sample, wherein the location of the ground truth box is an actual disease location;
training the improved YOLO V7 network model based on the calibrated training data sample by using a deep learning approach, to obtain an initial improved YOLO V7 network model; and
predicting the test data sample by using the initial improved YOLO V7 network model and updating a parameter of the initial improved YOLO V7 network model, to obtain the trained improved YOLO V7 network model.

3. The plant disease detection method according to claim 2, wherein the preprocessing the training data sample, to obtain a preprocessed training data sample comprises:
performing image size adjustment and data enhancement preprocessing on the training data sample, wherein an input resolution of the training data sample is adjusted to 640*640, and data enhancement preprocessing is performed by using Mix up and Mosaic data enhancement operations, to obtain the preprocessed training data sample.

4. The plant disease detection method according to claim 2, wherein the predicting the test data sample by using the initial improved YOLO V7 network model and updating a parameter of the initial improved YOLO V7 network model, to obtain the trained improved YOLO V7 network model comprises:
predicting the test data sample by using the initial improved YOLO V7 network model, and obtaining a location of a prediction box by using a first formula, wherein the location of the prediction box is a disease location predicted by the initial improved YOLO V7 network model;
calculating a loss value between the location of the prediction box and the location of the ground truth box by using a second formula based on the location of the prediction box; and
after performing backward propagation based on the loss value to complete updating of the parameter of the initial improved YOLO V7 network model parameter, continuing to perform training with a Stochastic Gradient Descent (SGD) optimizer until a predetermined condition for training completion is met, to obtain the trained improved YOLO V7 network model.

5. The plant disease detection method according to claim 4, wherein the first formula specifically comprises:
$${x}_{1} = 2 \times σ ( {t}_{x} ) - 0.5$$
$${x}_{2} = 2.2 \times σ ( {t}_{x} ) - 0.6$$
$${y}_{1} = 2 \times σ ( {t}_{y} ) - 0.5$$
$${y}_{2} = 2.2 \times σ ( {t}_{y} ) - 0.6$$
$${b}_{x} = \{ \begin{matrix}- 0.5 + {c}_{x} , & \frac{{x}_{1} + {x}_{2}}{2} < - 0.5 \\ \frac{{x}_{1} + {x}_{2}}{2} + {c}_{x} , & - 0.5 \leq \frac{{x}_{1} + {x}_{2}}{2} \leq 1.5 \\ 1.5 + {c}_{x} , & \frac{{x}_{1} + {x}_{2}}{2} > 1.5\end{matrix}$$
$${b}_{y} = \{ \begin{matrix}- 0.5 + {c}_{y} , & \frac{{y}_{1} + {y}_{2}}{2} < - 0.5 \\ \frac{{y}_{1} + {y}_{2}}{2} + {c}_{y} , & - 0.5 \leq \frac{{y}_{1} + {y}_{2}}{2} \leq 1.5 \\ 1.5 + {c}_{y} , & \frac{{y}_{1} + {y}_{2}}{2} > 1.5\end{matrix}$$
wherein bₓ and b_{y} represent a location of a target center point in the prediction box; σ represents a sigmoid function; tₓ and t_{y} respectively represent offsets of target centers x and y relative to an upper left corner of a prediction box grid; cₓ and c_{y} respectively represent original x and y coordinates corresponding to the upper left corner of the prediction box grid; x₁ and x₂ respectively represent offsets of the target center x of the prediction box grid that are obtained by using offset formulas of different weights; and y₁ and y₂ respectively represent offsets of the target center y of the prediction box grid that are obtained by using offset formulas of different weights.

6. The plant disease detection method according to claim 5, wherein the second formula specifically comprises:
$$APEIOU Loss = 1 - IOU + \frac{{p}^{2} ( b , {b}^{gt} )}{{( {w}^{c} )}^{2} + {( {h}^{c} )}^{2}} + \frac{{p}^{2} ( w , {w}^{gt} )}{{( {w}^{c} )}^{2}} + \frac{{p}^{2} ( h , {h}^{gt} )}{{( {h}^{c} )}^{2}} + \frac{\sqrt{{p}^{2} ( l , {l}^{gt} ) + {p}^{2} ( r , {r}^{gt} )}}{1 + {e}^{φ} + {p}^{2} ( b , {b}^{gt} )}$$
$$φ = \frac{\sqrt{{p}^{2} ( l , {l}^{gt} ) + {p}^{2} ( r , {r}^{gt} )}}{{( {w}^{c} )}^{2} + {( {h}^{c} )}^{2}}$$
wherein APEIOU Loss represents the loss value between the location of the prediction box and the location of the ground truth box; p²(b,b^{gt}) represents a square of an Euclidean distance between a center point b^{gt} of the ground truth box and a center point b of the prediction box; p²(w,w^{gt}) represents a square of an Euclidean distance between a width w of the prediction box and a width w^{gt} of the ground truth box; p²(h,h^{gt}) represents a square of an Euclidean distance between a height h of the prediction box and a height hot of the ground truth box; p²(l,l^{gt}) represents a square of an Euclidean distance between an upper left corner l^{gt} of the ground truth box and an upper left corner l of the prediction box; p²(r,r^{gt}) represents a square of an Euclidean distance between a lower right corner r^{gt} of the ground truth box and a lower right corner r of the prediction box; w^{c} and h^{c} respectively represent a width and a height of a minimum bounding rectangle of a prediction bounding box and a ground truth bounding box; and IOU represents an intersection over union of areas of the prediction box and the ground truth box.

7. The plant disease detection method according to claim 6, wherein the trained improved YOLO V7 network model further comprises a third formula, and the third formula is specifically:
$${X}^{*} = X \times σ ( α \times E - mean ( E ) )$$
wherein X is an input feature, and X* is a weighted feature; E is a neuron weight; mean(E) represents a mean value of the neuron weight; and α is a threshold coefficient of a threshold softening operation.

8. A non-transitory computer-readable storage medium, having a computer program stored therein, wherein the computer program, when executed by a processor, implements the plant disease detection method according to claim 1.

9. The non-transitory computer-readable storage medium according to claim 8, wherein a training process of the trained improved YOLO V7 network model comprises:
obtaining a plurality of plant leaf images and grouping them into a training data sample and test data sample, wherein the plurality of plant leaf images comprise diseased plant leaf images and disease-free plant leaf images;
preprocessing the training data sample, to obtain a preprocessed training data sample;
calibrating a location of a ground truth box on the preprocessed training data sample to obtain a calibrated training data sample, wherein the location of the ground truth box is an actual disease location;
training the improved YOLO V7 network model based on the calibrated training data sample by using a deep learning approach, to obtain an initial improved YOLO V7 network model; and
predicting the test data sample by using the initial improved YOLO V7 network model and updating a parameter of the initial improved YOLO V7 network model, to obtain the trained improved YOLO V7 network model.

10. The non-transitory computer-readable storage medium according to claim 9, wherein the preprocessing the training data sample, to obtain a preprocessed training data sample comprises:
performing image size adjustment and data enhancement preprocessing on the training data sample, wherein an input resolution of the training data sample is adjusted to 640*640, and data enhancement preprocessing is performed by using Mix up and Mosaic data enhancement operations, to obtain the preprocessed training data sample.

11. The non-transitory computer-readable storage medium according to claim 9, wherein the predicting the test data sample by using the initial improved YOLO V7 network model and updating a parameter of the initial improved YOLO V7 network model, to obtain the trained improved YOLO V7 network model comprises:
predicting the test data sample by using the initial improved YOLO V7 network model, and obtaining a location of a prediction box by using a first formula, wherein the location of the prediction box is a disease location predicted by the initial improved YOLO V7 network model;
calculating a loss value between the location of the prediction box and the location of the ground truth box by using a second formula based on the location of the prediction box; and
after performing backward propagation based on the loss value to complete updating of the parameter of the initial improved YOLO V7 network model parameter, continuing to perform training with a Stochastic Gradient Descent (SGD) optimizer until a predetermined condition for training completion is met, to obtain the trained improved YOLO V7 network model.

12. The non-transitory computer-readable storage medium according to claim 11, wherein the first formula specifically comprises:
$${x}_{1} = 2 \times σ ( {t}_{x} ) - 0.5$$
$${x}_{2} = 2.2 \times σ ( {t}_{x} ) - 0.6$$
$${y}_{1} = 2 \times σ ( {t}_{y} ) - 0.5$$
$${y}_{2} = 2.2 \times σ ( {t}_{y} ) - 0.6$$
$${b}_{x} = \{ \begin{matrix}- 0.5 + {c}_{x} , & \frac{{x}_{1} + {x}_{2}}{2} < - 0.5 \\ \frac{{x}_{1} + {x}_{2}}{2} + {c}_{x} , & - 0.5 \leq \frac{{x}_{1} + {x}_{2}}{2} \leq 1.5 \\ 1.5 + {c}_{x} , & \frac{{x}_{1} + {x}_{2}}{2} > 1.5\end{matrix}$$
$${b}_{y} = \{ \begin{matrix}- 0.5 + {c}_{y} , & \frac{{y}_{1} + {y}_{2}}{2} < - 0.5 \\ \frac{{y}_{1} + {y}_{2}}{2} + {c}_{y} , & - 0.5 \leq \frac{{y}_{1} + {y}_{2}}{2} \leq 1.5 \\ 1.5 + {c}_{y} , & \frac{{y}_{1} + {y}_{2}}{2} > 1.5\end{matrix}$$
wherein bₓ and b_{y} represent a location of a target center point in the prediction box; represents a sigmoid function; tₓ and t_{y} respectively represent offsets of target centers x and y relative to an upper left corner of a prediction box grid; cₓ and c_{y} respectively represent original x and y coordinates corresponding to the upper left corner of the prediction box grid; x₁ and x₂ respectively represent offsets of the target center x of the prediction box grid that are obtained by using offset formulas of different weights; and y₁ and y₂ respectively represent offsets of the target center y of the prediction box grid that are obtained by using offset formulas of different weights.

13. The non-transitory computer-readable storage medium according to claim 12, wherein the second formula specifically comprises:
$$APEIOU Loss = 1 - IOU + \frac{{p}^{2} ( b , {b}^{gt} )}{{( {w}^{c} )}^{2} + {( {h}^{c} )}^{2}} + \frac{{p}^{2} ( w , {w}^{gt} )}{{( {w}^{c} )}^{2}} + \frac{{p}^{2} ( h , {h}^{gt} )}{{( {h}^{c} )}^{2}} + \frac{\sqrt{{p}^{2} ( l , {l}^{gt} ) + {p}^{2} ( r , {r}^{gt} )}}{1 + {e}^{φ} + {p}^{2} ( b , {b}^{gt} )}$$
$$φ = \frac{\sqrt{{p}^{2} ( l , {l}^{gt} ) + {p}^{2} ( r , {r}^{gt} )}}{{( {w}^{c} )}^{2} + {( {h}^{c} )}^{2}}$$
wherein APEIOU Loss represents the loss value between the location of the prediction box and the location of the ground truth box; p²(b,b^{gt}) represents a square of an Euclidean distance between a center point b^{gt} of the ground truth box and a center point b of the prediction box; p²(w,w^{gt}) represents a square of an Euclidean distance between a width w of the prediction box and a width w^{gt} of the ground truth box; p²(h,h^{gt}) represents a square of an Euclidean distance between a height h of the prediction box and a height h^{gt} of the ground truth box; p²(l,l^{gt}) represents a square of an Euclidean distance between an upper left corner l^{gt} of the ground truth box and an upper left corner l of the prediction box; p²(r,r^{gt}) represents a square of an Euclidean distance between a lower right corner r^{gt} of the ground truth box and a lower right corner r of the prediction box; w^{c} and h^{c} respectively represent a width and a height of a minimum bounding rectangle of a prediction bounding box and a ground truth bounding box; and IOU represents an intersection over union of areas of the prediction box and the ground truth box.

14. The non-transitory computer-readable storage medium according to claim 13, wherein the trained improved YOLO V7 network model further comprises a third formula, and the third formula is specifically:
$${X}^{*} = X \times σ ( α \times E - mean ( E ) )$$
wherein X is an input feature, and X* is a weighted feature; E is a neuron weight; mean(E) represents a mean value of the neuron weight; and α is a threshold coefficient of a threshold softening operation.

15. A computer device, comprising: a memory, a processor, and a computer program stored in the memory and executable on the processor, wherein the processor executes the computer program, to implement the plant disease detection method according to claim 1.

16. The computer device according to claim 15, wherein a training process of the trained improved YOLO V7 network model comprises:
obtaining a plurality of plant leaf images and grouping them into a training data sample and test data sample, wherein the plurality of plant leaf images comprise diseased plant leaf images and disease-free plant leaf images;
preprocessing the training data sample, to obtain a preprocessed training data sample;
calibrating a location of a ground truth box on the preprocessed training data sample to obtain a calibrated training data sample, wherein the location of the ground truth box is an actual disease location;
training the improved YOLO V7 network model based on the calibrated training data sample by using a deep learning approach, to obtain an initial improved YOLO V7 network model; and
predicting the test data sample by using the initial improved YOLO V7 network model and updating a parameter of the initial improved YOLO V7 network model, to obtain the trained improved YOLO V7 network model.

17. The computer device according to claim 16, wherein the preprocessing the training data sample, to obtain a preprocessed training data sample comprises:
performing image size adjustment and data enhancement preprocessing on the training data sample, wherein an input resolution of the training data sample is adjusted to 640*640, and data enhancement preprocessing is performed by using Mix up and Mosaic data enhancement operations, to obtain the preprocessed training data sample.

18. The computer device according to claim 16, wherein the predicting the test data sample by using the initial improved YOLO V7 network model and updating a parameter of the initial improved YOLO V7 network model, to obtain the trained improved YOLO V7 network model comprises:
predicting the test data sample by using the initial improved YOLO V7 network model, and obtaining a location of a prediction box by using a first formula, wherein the location of the prediction box is a disease location predicted by the initial improved YOLO V7 network model;
calculating a loss value between the location of the prediction box and the location of the ground truth box by using a second formula based on the location of the prediction box; and
after performing backward propagation based on the loss value to complete updating of the parameter of the initial improved YOLO V7 network model parameter, continuing to perform training with a Stochastic Gradient Descent (SGD) optimizer until a predetermined condition for training completion is met, to obtain the trained improved YOLO V7 network model.

19. The computer device according to claim 18, wherein the first formula specifically comprises:
$${x}_{1} = 2 \times σ ( {t}_{x} ) - 0.5$$
$${x}_{2} = 2.2 \times σ ( {t}_{x} ) - 0.6$$
$${y}_{1} = 2 \times σ ( {t}_{y} ) - 0.5$$
$${y}_{2} = 2.2 \times σ ( {t}_{y} ) - 0.6$$
$${b}_{x} = \{ \begin{matrix}- 0.5 + {c}_{x} , & \frac{{x}_{1} + {x}_{2}}{2} < - 0.5 \\ \frac{{x}_{1} + {x}_{2}}{2} + {c}_{x} , & - 0.5 \leq \frac{{x}_{1} + {x}_{2}}{2} \leq 1.5 \\ 1.5 + {c}_{x} , & \frac{{x}_{1} + {x}_{2}}{2} > 1.5\end{matrix}$$
$${b}_{y} = \{ \begin{matrix}- 0.5 + {c}_{y} , & \frac{{y}_{1} + {y}_{2}}{2} < - 0.5 \\ \frac{{y}_{1} + {y}_{2}}{2} + {c}_{y} , & - 0.5 \leq \frac{{y}_{1} + {y}_{2}}{2} \leq 1.5 \\ 1.5 + {c}_{y} , & \frac{{y}_{1} + {y}_{2}}{2} > 1.5\end{matrix}$$
wherein bₓ and b_{y} represent a location of a target center point in the prediction box; σ represents a sigmoid function; tₓ and t_{y} respectively represent offsets of target centers x and y relative to an upper left corner of a prediction box grid; cₓ and c_{y} respectively represent original x and y coordinates corresponding to the upper left corner of the prediction box grid; x₁ and x₂ respectively represent offsets of the target center x of the prediction box grid that are obtained by using offset formulas of different weights; and y₁ and y₂ respectively represent offsets of the target center y of the prediction box grid that are obtained by using offset formulas of different weights.

20. The computer device according to claim 19, wherein the second formula specifically comprises:
$$APEIOU Loss = 1 - IOU + \frac{{p}^{2} ( b , {b}^{gt} )}{{( {w}^{c} )}^{2} + {( {h}^{c} )}^{2}} + \frac{{p}^{2} ( w , {w}^{gt} )}{{( {w}^{c} )}^{2}} + \frac{{p}^{2} ( h , {h}^{gt} )}{{( {h}^{c} )}^{2}} + \frac{\sqrt{{p}^{2} ( l , {l}^{gt} ) + {p}^{2} ( r , {r}^{gt} )}}{1 + {e}^{φ} + {p}^{2} ( b , {b}^{gt} )}$$
$$φ = \frac{\sqrt{{p}^{2} ( l , {l}^{gt} ) + {p}^{2} ( r , {r}^{gt} )}}{{( {w}^{c} )}^{2} + {( {h}^{c} )}^{2}}$$
wherein APEIOU Loss represents the loss value between the location of the prediction box and the location of the ground truth box; p²(b,b^{gt}) represents a square of an Euclidean distance between a center point b^{gt} of the ground truth box and a center point b of the prediction box; p²(w,w^{gt}) represents a square of an Euclidean distance between a width w of the prediction box and a width w^{gt} of the ground truth box; p²(h,h^{gt}) represents a square of an Euclidean distance between a height h of the prediction box and a height h^{gt} of the ground truth box; p²(l,l^{gt}) represents a square of an Euclidean distance between an upper left corner l^{gt} of the ground truth box and an upper left corner l of the prediction box; p²(r,r^{gt}) represents a square of an Euclidean distance between a lower right corner r^{gt} of the ground truth box and a lower right corner r of the prediction box; w^{c} and h^{c} respectively represent a width and a height of a minimum bounding rectangle of a prediction bounding box and a ground truth bounding box; and IOU represents an intersection over union of areas of the prediction box and the ground truth box.
